(19) United States
(12) Patent Application Publication
(10) Pub. No.: US 2013/0240131 A1
(43) Pub. Date: Sep. 19, 2013

(54) METHOD OF FABRICATING SEMICONDUCTOR DEVICE AND SEMICONDUCTOR PRODUCTION APPARATUS

(71) Applicant: KABUSHIKI KAISHA TOSHIBA, Tokyo (JP)

(72) Inventor: Akira EZAKI, Hyogo-ken (JP)

(73) Assignee: KABUSHIKI KAISHA TOSHIBA, Tokyo (JP)

(21) Appl. No.: 13/781,608

(22) Filed: Feb. 28, 2013

(30) Foreign Application Priority Data
Mar. 14, 2012 (JP) 2012-057280

(51) Int. Cl. B29C 53/04

(52) U.S. Cl. CPC B29C 53/04
USPC 156/212; 156/750

(57) ABSTRACT

An aspect of the present embodiment, there is provided a method of fabricating a semiconductor device, including curving a semiconductor substrate onto which a protection tape is bonded, and removing the protection tape in a state where the semiconductor substrate is curved.

### CROSS REFERENCE TO RELATED APPLICATION

This application is based upon and claims the benefit of priority from prior Japanese Patent Application No. 2012-057280, filed on Mar. 14, 2012, the entire contents of which are incorporated herein by reference.

### FIELD

Embodiments relate to a method of fabricating a semiconductor device and a semiconductor production apparatus.

### BACKGROUND

In fabricating a semiconductor device, a semiconductor element is formed on a semiconductor substrate (wafer) and then a back surface of the wafer is subjected to grinding, polishing, and the like, thus reducing the thickness of the wafer.

In the process of reducing the thickness of the wafer, in order to protect the semiconductor device formed on a side of a main surface of the wafer, a surface protection tape (hereinafter, referred to as back side grinding (BSG) tape) is bonded to the main surface of the wafer and then the back surface of the wafer is subjected to grinding, polishing, and the like, thus reducing the thickness of the wafer. The BSG tape is removed after the thickness of the wafer is reduced.

When the BSG tape is removed, the wafer is placed on an adsorption stage with the back surface of the wafer facing down. Then, a removal tape is pressure-bonded to a main surface of the BSG tape. The BSG tape is integrally removed with the removal tape. Generally, the BSG tape is removed from the main surface of the wafer in such a manner.

However, after the thickness of the wafer is reduced, the mechanical strength (rigidity) of the wafer, particularly a wafer with the thickness smaller than 80 μm, is reduced. Therefore, when the protection tape is removed, the wafer floats on the adsorption stage and is deformed, with the result that problems such as cracks, fractures, and the like occur in the wafer.

In view of the problems, various methods have been conventionally proposed in order to prevent the wafer from being deformed and cracks, fractures, and the like from occurring when the protection tape is removed.

### BRIEF DESCRIPTION OF THE DRAWINGS

FIG. 1 is a cross-sectional view showing a configuration of a semiconductor production apparatus according to a first embodiment;

FIGS. 2A, 2B, and 2C are a front view, a side view, and an overhead view, respectively, showing a configuration of an adsorption stage and a configuration of a press unit of the semiconductor production apparatus according to the first embodiment;

FIG. 3 is a front view showing a bonding roller of the semiconductor production apparatus according to the first embodiment;

FIGS. 4A and 4B are cross-sectional views each showing an operation of the semiconductor production apparatus according to the first embodiment;

FIGS. 5A and 5B are cross-sectional views each showing an operation of the semiconductor production apparatus according to the first embodiment;

FIGS. 6A and 6B are cross-sectional views each showing an operation of the semiconductor production apparatus according to the first embodiment; and

FIGS. 7A and 7B are overhead views each showing a configuration of an adsorption stage according to a second embodiment.

### DETAILED DESCRIPTION

An aspect of the present embodiment, there is provided a method of fabricating a semiconductor device, including curving a semiconductor substrate onto which a protection tape is bonded, and removing the protection tape in a state where the semiconductor substrate is curved.

Another aspect of the present embodiment, there is provided a semiconductor production apparatus including a stage having a mounting surface with a curved shape and maintaining a semiconductor substrate onto which a protection tape is bonded, on the mounting surface in a state that the curved shape is maintained, and a removing unit removing the protection tape bonded onto the semiconductor substrate maintained on the mounting surface.

### First Embodiment

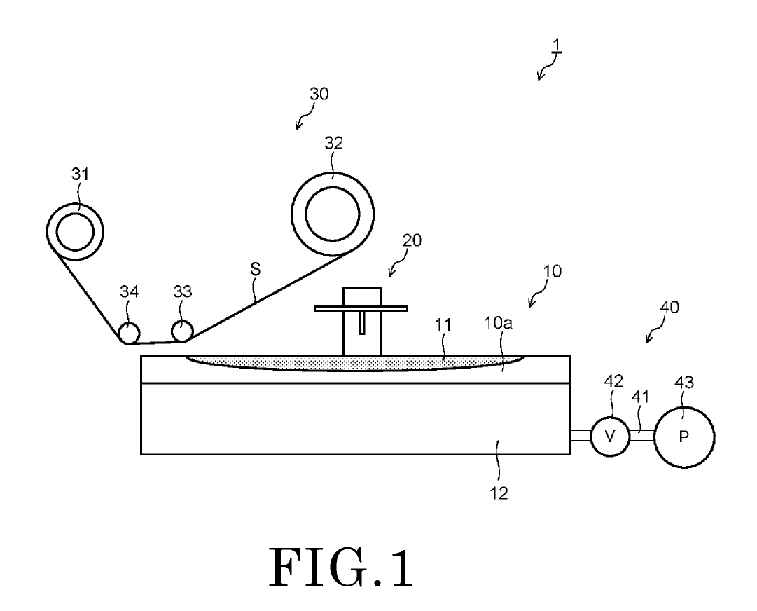

FIG. 1 is a cross-sectional view showing a configuration of a semiconductor production apparatus according to a first embodiment. A semiconductor production apparatus 1 is a removing apparatus to remove a surface protection tape B (hereinafter, referred to as back side grinding (BSG) tape B) bonded to a semiconductor substrate W (wafer W). The semiconductor production apparatus 1 includes an adsorption stage 10, a press unit 20, a removing unit 30, and a vacuum unit 40.

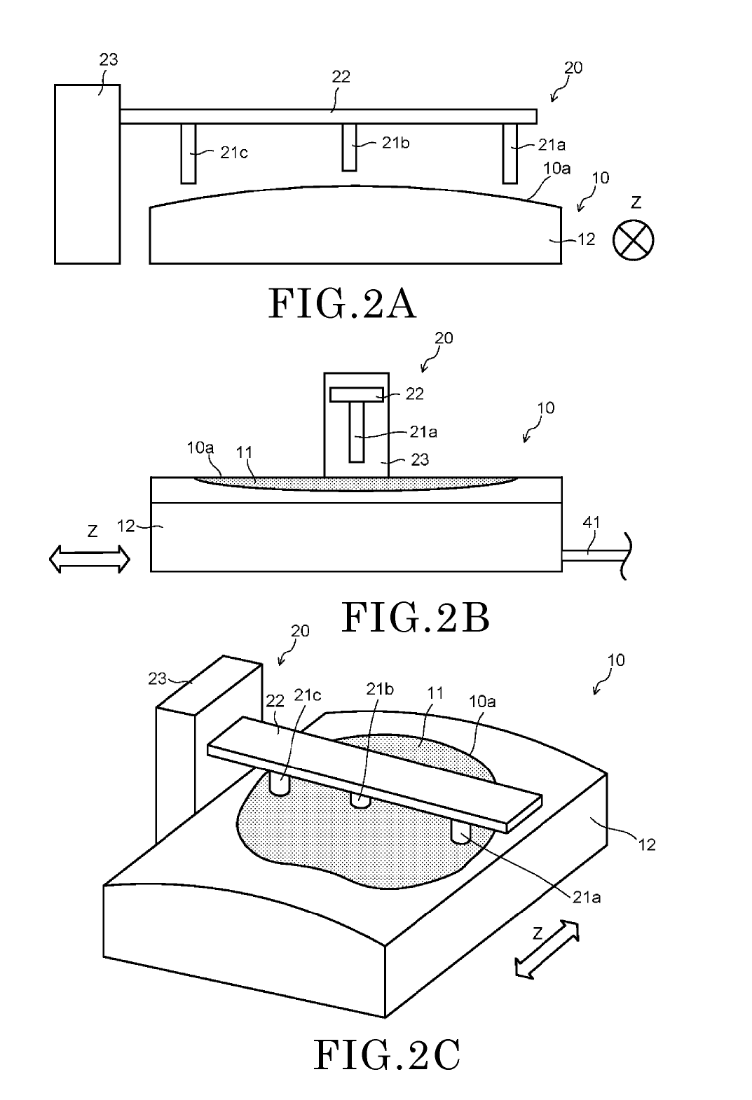

FIGS. 2A, 2B, and 2C are a front view, a side view, and an overhead view, respectively, showing a configuration of the adsorption stage 10 and a configuration of the press unit 20.

The adsorption stage 10 includes a porous adsorption portion 11 and a frame 12. The porous adsorption portion 11 is formed by sintering and molding metal or ceramic particles. The frame 12 fixes the adsorption portion 11. The top surface of the adsorption stage 10 serves as a mounting surface 10a on which the wafer W is placed. The adsorption portion 11 has a diameter substantially the same as that of the wafer W. The adsorption stage 10 is connected to the vacuum unit 40.

As shown in FIGS. 2A, 2B, and 2C, the adsorption stage 10 has a semicylindrical shape in which a cross-sectional shape of the mounting surface 10a of the adsorption stage 10 viewed in a Z direction is gently curved to be convex. In the case where the thickness of the wafer W is smaller than 80 μm, problems that the wafer W is deformed and cracks, fractures, and the like occur in the wafer may be caused when the protection tape is removed. Therefore, the thickness of the wafer W, from which the BSG tape B is removed, is preferably smaller than 80 μm in the embodiment.

The press unit 20 includes a plurality of press pins 21a, 21b, 21c, a supporting plate 22, and a driving unit 23. The supporting plate 22 supports the plurality of press pins 21a, 21b, 21c. The driving unit 23 is coupled to the supporting plate 22. The plurality of press pins 21a, 21b, 21c is a group of pins, with which the wafer W, to which the BSG tape B is bonded and whose thickness is reduced by grinding, is adsorbed along the shape of the mounting surface 10a of the adsorption stage 10.

The pin 21b arranged in the middle of the plurality of press pins 21a, 21b, 21c is shortest, and the pins 21a, 21c arranged on both sides of the pin 21b are longer than the pin 21b. The driving unit 23 is an air cylinder, for example. The driving unit 23 drives the supporting plate 22 in a substantially perpendicular direction to the adsorption stage 10.

As shown in FIG. 1, the removing unit 30 includes a supply reel 31, a rolling reel 32, a bonding roller 33, and a guide roller 34. A removal tape S to remove the BSG tape B bonded to the wafer W is supplied from the supply reel 31 and rolled up together with the removed BSG tape B by the rolling reel 32. The bonding roller 33 bonds the removal tape S to the BSG tape B. The guide roller 34 controls a supply position (height) of the removal tape S.

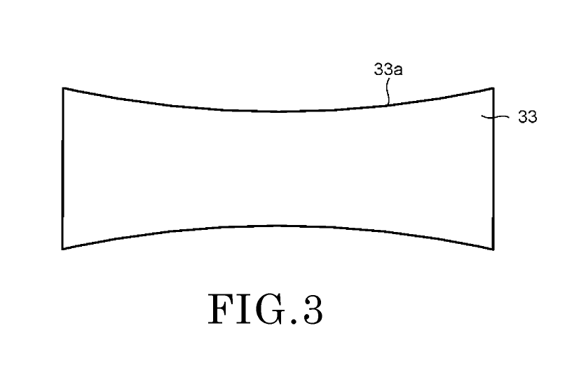

FIG. 3 is a front view showing the bonding roller 33. As shown in FIG. 3, an outer peripheral surface 33a of the bonding roller 33 has a curved shape that fits the shape of the mounting surface 10a of the adsorption stage 10.

As shown in FIG. 1, the vacuum unit 40 includes a vacuum pipe 41, a valve 42, and a vacuum pump 43. The vacuum pipe 41 is connected to the adsorption stage 10 at one end of the vacuum pipe 41. The valve 42 is provided in a path of the vacuum pipe 41. The vacuum pump 43 is connected to the vacuum pipe 41 at the other end of the vacuum pipe 41. The valve 42 is opened and closed by clean dry air (CDA) or N₂ gas supplied from an outside. The valve 42 used in the embodiment is a normal close (NC) valve. However, the valve 42 may be a normal open (NO) valve.

(Operation of Semiconductor Production Apparatus 1)

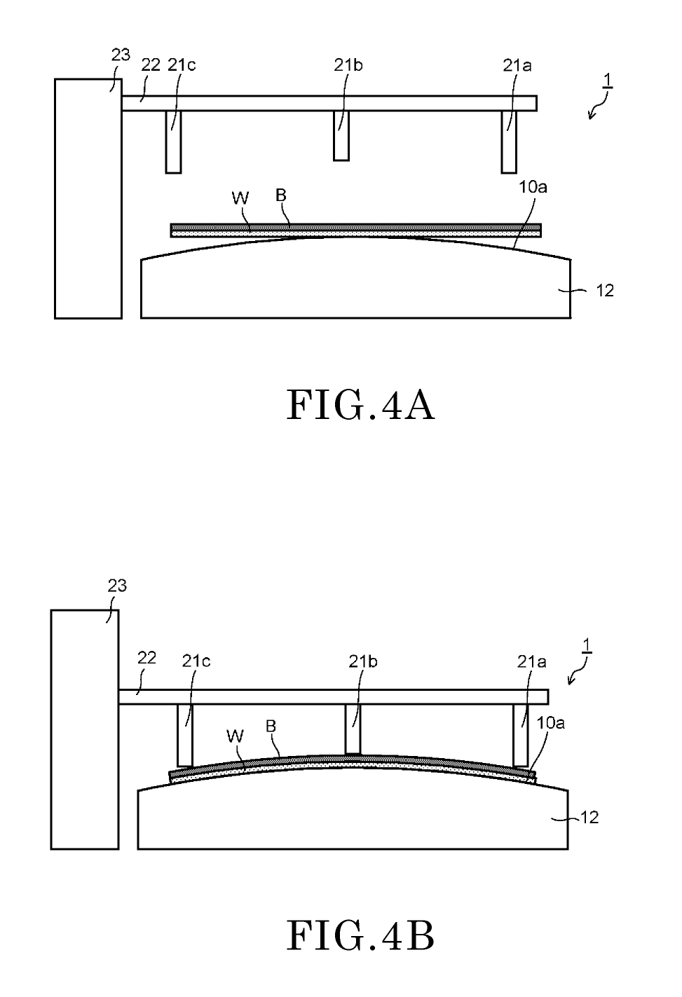

FIGS. 4A to 6B are cross-sectional views each showing an operation of the semiconductor production apparatus 1. Hereinafter, operations of the semiconductor production apparatus 1 to remove the BSG tape B will be described with reference to FIGS. 4A to 6B. In the embodiment, the removal tape S is set in the supply reel 31 and the rolling reel 32 in advance.

As shown in FIG. 4A, the wafer W, to which the BSG tape B is bonded and whose thickness is reduced by grinding, is placed on the mounting surface 10a of the adsorption stage 10.

As shown in FIG. 4B, the driving unit 23 lowers the supporting plate 22 with respect to the adsorption stage 10. The wafer W, to which the BSG tape B is bonded, is aligned with the shape of the mounting surface 10a of the adsorption stage 10 by using the press pins 21a, 21b, 21c.

The CDA or N₂ gas is supplied to the valve 42 of the vacuum unit 40 so that the valve 42 is opened. Then, the wafer W is adsorbed to the porous adsorption portion 11. Note that the driving unit 23 may lower the supporting plate 22 with respect to the adsorption stage 10 after the CDA or N₂ gas is supplied to the valve 42, to open the valve 42.

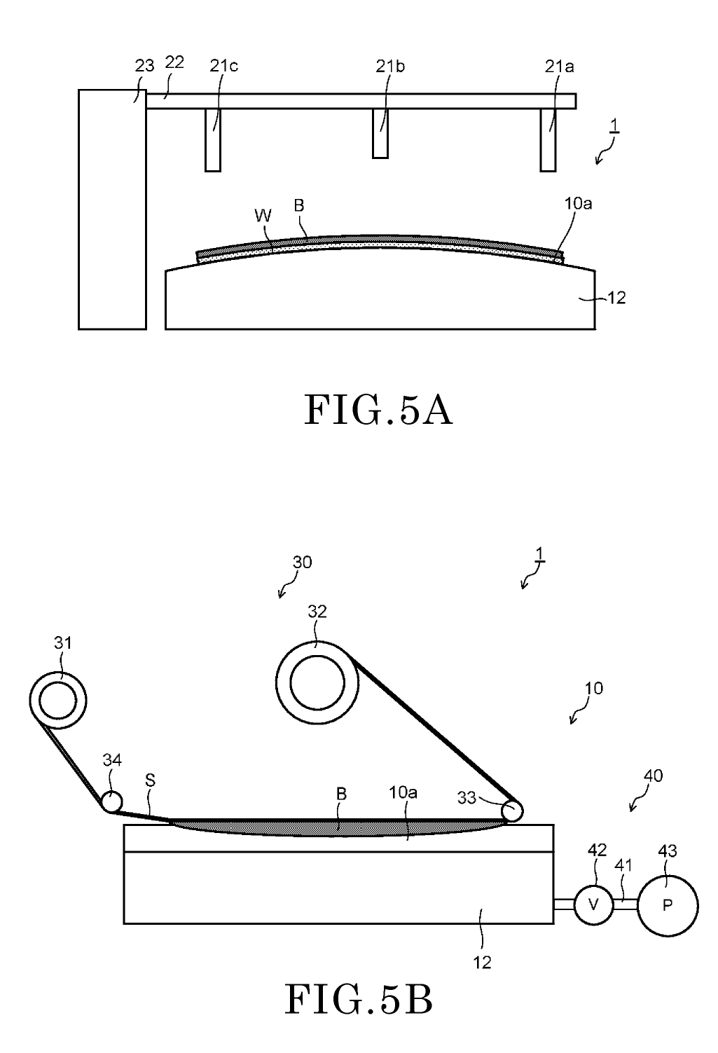

As shown in FIG. 5A, after the wafer W is adsorbed onto the adsorption portion 11 of the adsorption stage 10, the driving unit 23 lifts the supporting plate 22 with respect to the adsorption stage 10 to retract the plurality of press pins 21a, 21b, 21c. Note that the valve 42 remains open, that is, the wafer W is kept to be adsorbed.

As shown in FIG. 5B, the removal tape S is drawn from the supply reel 31 of the removing unit 30 along with a horizontal movement of the bonding roller 33. The bonding roller 33 is lowered in front of the wafer W and moves forward in a horizontal direction while pressing a main surface of the BSG tape B. Thus, the removal tape S is bonded to the BSG tape B.

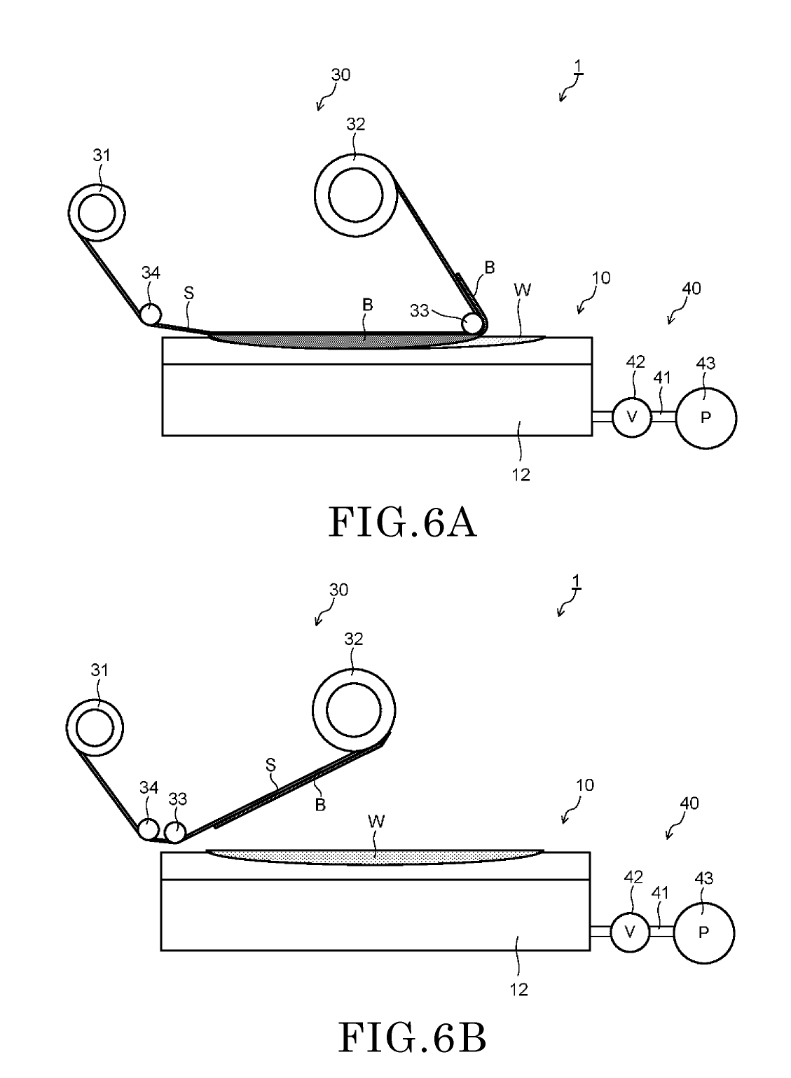

As shown in FIG. 6A, the rolling reel 32 is rotated to roll up the BSG tape B bonded to the wafer W while removing the BSG tape B from the wafer W. As shown in FIG. 6B, after the BSG tape B is completely removed from the wafer W, the supply of the CDA or N₂ gas to the valve 42 is stopped so that the valve 42 is closed. The wafer W, from which the BSG tape is removed, is taken out from the adsorption stage 10. Thus, the operations are terminated.

As described above, in the semiconductor production apparatus 1 according to the first embodiment, the wafer W, to which the BSG tape B is bonded, is aligned with the shape of the mounting surface 10a of the adsorption stage 10 and adsorbed onto the adsorption stage 10. The adsorption stage 10 has a semicylindrical shape when viewed in the Z direction of the mounting surface 10a of the adsorption stage 10. After that, the semiconductor production apparatus 1 keeps the curved state of the wafer W and removes the BSG tape B from the wafer W along the Z direction in which the wafer W has a curved cross section.

In other words, in the semiconductor production apparatus 1, the mechanical strength (rigidity) of the wafer W is increased because the BSG tape B is removed in a state where the wafer W is curved. Therefore, when the BSG tape B is removed, the semiconductor production apparatus 1 can effectively prevent the wafer W from floating on the adsorption stage 10 to be deformed and cracks, fractures, and the like from occurring in the wafer W.

Further, it is unnecessary to use a self-removal tape, for example, as a special BSG tape. In the self-removal tape, a pressure-sensitive adhesive foams due to the application of heat or ultraviolet rays and thus an adhesive force is reduced. Therefore, the production cost of the semiconductor device can be reduced.

In addition, the press pins 21a, 21b, 21c are caused to abut against the BSG tape B so that the wafer W is pressed against the mounting surface 10a of the adsorption stage 10. Therefore, the press pins 21a, 21b, 21c and the wafer W do not come into contact with each other. As a result, fractures or chipping of the wafer W due to the load of the press pins 21a, 21b, 21c are effectively prevented.

### Second Embodiment

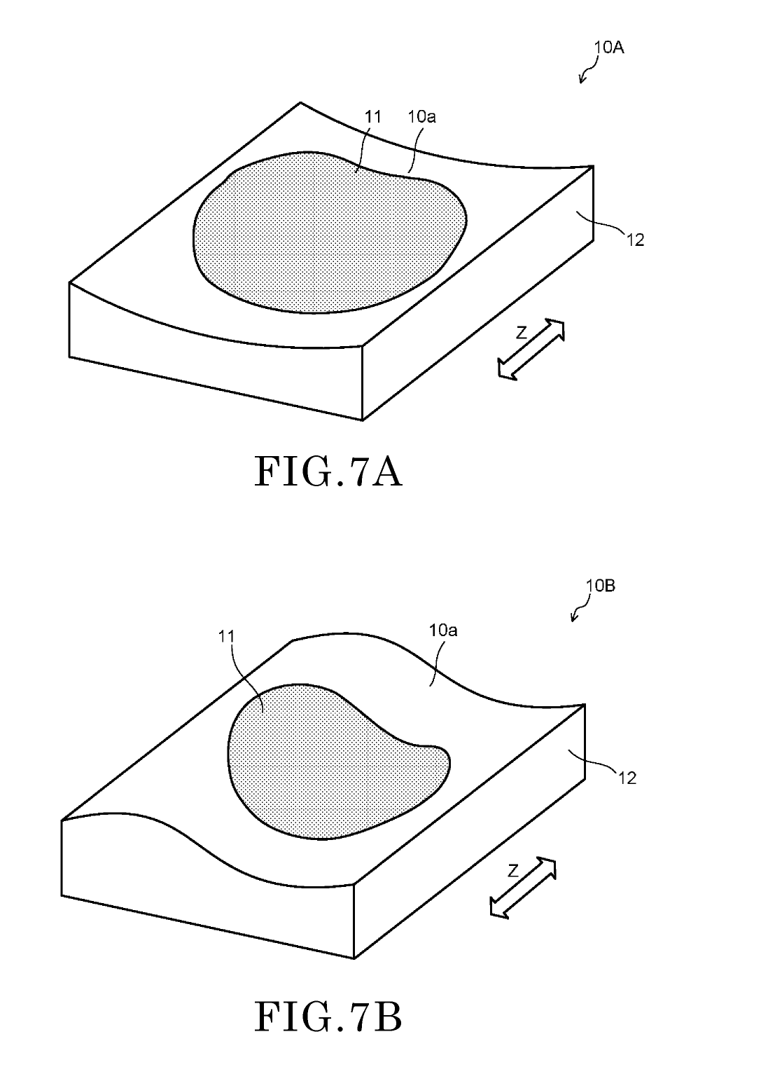

FIGS. 7A and 7B are overhead views showing an adsorption stage 10A and an adsorption stage 10B according to the second embodiment, respectively. The adsorption stage 10 of the semiconductor production apparatus 1 according to the first embodiment has a shape in which a cross-sectional shape of the mounting surface 10a viewed in the Z direction is gently curved to be convex. On the other hand, the adsorption stage 10A shown in FIG. 7A has a shape in which a cross-sectional shape of the mounting surface 10a viewed in the Z direction is gently curved to be concave. Further, the adsorption stage 10B shown in FIG. 7B has a shape in which a cross-sectional shape of the mounting surface 10a viewed in the Z direction is wavy.

Also in the cases of FIGS. 7A and 7B showing the cross-sectional shapes of the mounting surface 10a viewed in the Z direction, the mechanical strength of the wafer W is increased. As a result, when the BSG tape B is removed, it is effectively prevented that the wafer W floats on the adsorption stage 10 to be deformed and cracks, fractures, and the like occur in the wafer W. Other effects are the same as those produced by the semiconductor production apparatus 1 according to the first embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of fabricating a semiconductor device, comprising:
curving a semiconductor substrate onto which a protection tape is bonded; and
removing the protection tape in a state where the semiconductor substrate is curved.

2. The method of claim 1, wherein
the protection tape is removed along a direction in which a cross sectional view of the semiconductor substrate has a curved shape.

3. The method of claim 2, further comprising:
bonding a removal tape onto the protection tape,
wherein the removal tape is integrally removed with the protection tape to remove the protection tape from the semiconductor substrate.

4. The method of claim 2, wherein
the semiconductor substrate has a thickness of smaller than 80 μm.

5. The method of claim 2, wherein
in the curving, the semiconductor substrate is curved to be a semicylindrical shape.

6. The method of claim 2, wherein
in the curving, the semiconductor substrate is curved to be a convex shape.

7. The method of claim 2, wherein
in the curving, the semiconductor substrate is curved to be a wave shape.

8. A method of fabricating a semiconductor device, comprising:
curving a semiconductor substrate onto which a protection tape is bonded, the semiconductor substrate having a thickness of smaller than 80 μm;
bonding a removal tape onto the protection tape; and
integrally removing the removal tape with the protection tape to remove the protection tape from the semiconductor substrate along a direction in which a cross sectional view of the semiconductor substrate is a curved shape, in a state where the semiconductor substrate is curved.

9. A semiconductor production apparatus, comprising:
a stage having a mounting surface with a curved shape and maintaining a semiconductor substrate onto which a protection tape is bonded, on the mounting surface in a state that the curved shape is maintained; and
a removing unit removing the protection tape bonded onto the semiconductor substrate maintained on the mounting surface.

10. The apparatus of claim 9, further comprising:
a press unit pressing the semiconductor substrate on the mounting surface to arrange the semiconductor substrate on the stage to a curved state.

11. The apparatus of claim 9, further comprising:
a vacuum unit to evacuate air in the stage to be set as a vacuum state to adsorb the semiconductor substrate onto the stage.

12. The apparatus of claim 9, wherein
the stage includes a porous adsorption portion and the semiconductor substrate is placed on the stage.

13. The apparatus of claim 12, wherein
the porous adsorption portion is composed of sintered and molded metal or ceramic particles.

14. The apparatus of claim 9, wherein
the removing unit supplies a removal tape, bonds the removal tape onto the protection tape and integrally removes the removal tape with the protection tape.

15. The apparatus of claim 9, wherein the removing unit includes a supply reel, a guide roller, a bonding roller and rolling reel, the supply reel supplies the removal tape, the guide roller controls a position of the removal tape, the bonding roller bonds the removal tape onto the protection tape, and the rolling reel integrally rolls up the removal tape with the protection tape.

16. The apparatus of claim 9, wherein
the press unit include a plurality of press pins, a supporting plate and a driving unit, the plurality of press pins adsorbs the semiconductor substrate on the stage, the supporting plate supports the plurality of press pins, and the driving unit drives the supporting plate.

17. The apparatus of claim 16, wherein
a pin arranged in a middle of the plurality of press pins has the shortest length.

18. The apparatus of claim 9, wherein
the vacuum unit includes a vacuum pipe, a valve and a vacuum pump, one end of the vacuum pipe is connected to the stage, the valve is provided in a path of the vacuum pipe, and the vacuum pump is connected to the vacuum pipe at the other end of the vacuum pipe.
